(19) United States
(12) Patent Application Publication
(10) Pub. No.: US 2009/0117850 A1
(43) Pub. Date: May 7, 2009

(54) Electronic device light messaging

(75) Inventor: Teppo Tapani Jokinen, Copenhagen (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/982,567

(22) Filed: Nov. 2, 2007

(51) Int. Cl. H04B 7/00

(52) U.S. Cl. 455/66.1

(57) ABSTRACT

Disclosed herein is an electronic device. The electronic device includes a housing and a transmitter. The transmitter is within the housing. The transmitter is configured to transmit an electronic communication. The electronic communication includes a light indicating signal. The electronic device is configured to allow a user to select the light indicating signal.

### BACKGROUND OF THE INVENTION

1. Field of the Invention

The invention relates to an electronic device and, more particularly, to light messaging for an electronic device.

2. Brief Description of Prior Developments

As electronic devices continue to become more sophisticated, these devices provide an increasing amount of functionality by including such applications as, for example, a mobile phone, short message service (SMS) or text messaging, electronic mail, and internet browser applications. These applications provide several forms of communication other than traditional wireless voice communication. Many mobile electronic device manufacturers also provide various lights for the basic functions of screen visibility and key pad illumination. As consumers demand increased communication features from electronic devices, there is a need to provide improved devices which use lights to enrich and improve user experiences, and provide an increased level of communication. Additionally, it is desired to implement these features within ever shrinking space constraints while maintaining robust and reliable product configurations.

Accordingly, there is a desire to provide additional forms of communication in electronic devices other than traditional voice/text applications.

### SUMMARY OF THE INVENTION

In accordance with one aspect of the invention, an electronic device is disclosed. The electronic device includes a housing and a transmitter. The transmitter is within the housing. The transmitter is configured to transmit an electronic communication. The electronic communication includes a light indicating signal. The electronic device is configured to allow a user to select the light indicating signal.

In accordance with another aspect of the invention, an apparatus is disclosed. The apparatus includes a housing, a receiver, and a lighting system. The receiver is within the housing. The receiver is adapted to receive a first electronic communication and a second electronic communication. The lighting system is connected to the housing. The lighting system is adapted to operate in response to a first indicator of the first electronic communication. The lighting system is adapted to operate in response to a second indicator of the second electronic communication.

In accordance with another aspect of the invention, a method is disclosed. A light indicating signal is selected. The light indicating signal is assigned to an electronic communication. The light indicating signal and the electronic communication are transmitted to an electronic device.

In accordance with another aspect of the invention, a method is disclosed. A first electronic communication is received. The first electronic communication includes a first light indicating signal. A second electronic communication is received. The second electronic communication includes a second light indicating signal. A lighting system is operated in response to the first and the second light indicating signals.

In accordance with another aspect of the invention, a program storage device readable by a machine, tangibly embodying a program of instructions executable by the machine for performing operations to provide light messaging with an electronic communication is disclosed. A light indicating signal is selected. The light indicating signal is assigned to the electronic communication. The light indicating signal and the electronic communication are transmitted to an electronic device.

### BRIEF DESCRIPTION OF THE DRAWINGS

The foregoing aspects and other features of the invention are explained in the following description, taken in connection with the accompanying drawings, wherein:

FIG. 1 is a perspective view of a portable electronic device comprising features of the invention;

FIG. 2 is perspective view of two communicating portable electronic devices comprising features of the invention;

FIG. 3 is block diagram of an exemplary method for sending a light message;

FIG. 4 is block diagram of an exemplary method for receiving a light message; and

FIG. 5 is a schematic diagram illustrating components of the portable electronic device(s) shown in FIGS. 1 and 2.

### DETAILED DESCRIPTION OF THE PREFERRED EMBODIMENT

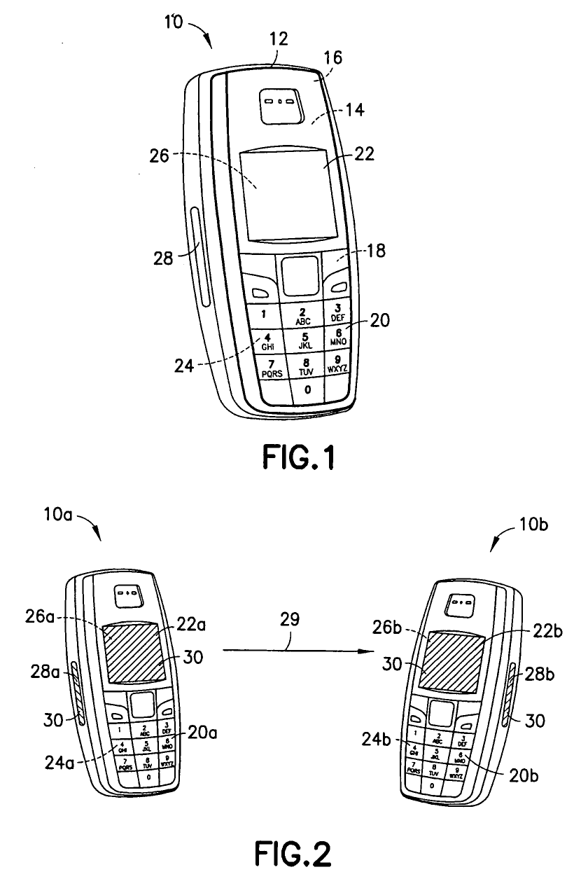

Referring to FIG. 1, there is shown a perspective view of a portable electronic device 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

In this embodiment the device 10 comprises a mobile telephone. However, in alternate embodiments the device could comprise any suitable type of electronic device. For example, the device 10 could comprise a digital camera, a music player, a hand-held gaming device, a PDA, or a notebook computer. The telephone 10 generally comprises a housing 12, a transmitter/receiver 14 connected to an antenna 16, electronic circuitry 18, such as a controller for example, within the housing 12, a keypad 20 and a display 22. In alternate embodiments, the telephone 10 can have any suitable type of features as known in the art. In the embodiment shown the device 10 comprises a single keypad 10 and a single display 22. However, alternate embodiments may comprise additional keypads or displays, or perhaps merely a touch screen display.

The electronic device 10 may also comprise light elements such as key mat (or keypad) lights 24 and display lights 26. Additionally, the electronic device 10 may comprise light elements at locations other than the keypad 20 and the display 22. For example, the electronic device may comprise a light element 28 at a side of the phone. It should be noted that although the figures illustrate the light element 28 at a side of the phone, alternate embodiments may comprise light elements at any suitable location. The light element 28 may be any suitable light element such as a light-emitting diodes (LED), a multicolor LED, a light guide, or electroluminescent (EL) foil, for example.

One or more of the light elements 24, 26, 28 provide for light messaging between electronic devices. The use of the light elements 24, 26, 28 for light messaging may comprise software to support and control the desired effects. The software may be an improved short message service (SMS), or text messaging, application for example. Alternatively, the electronic device 10 may comprise a separate software package to control the light elements 24, 26, 28 in light messaging applications. However, it should be noted that any suitable software configuration may be provided.

Light messaging allows a user to express a mood while having an ongoing call or while sending a text message. The light messaging may set the tone of the communication. People react to lights and colors very deeply and emotionally. Thus, using lights of an electronic device for light messaging allows enriched and improved user experiences with a new level of communication.

Referring now also to FIG. 2, there is shown a first electronic device 10a and a second electronic device 10b. It should be noted that the electronic device 10 is similar to the electronic devices 10a, 10b and similar features are similarly numbered. Additionally, any references made to a similarly numbered feature, such as the display 22a for example, apply equally to the other similarly numbered features, such as the display 22, 22b for example. Additionally, the communication path (shown as arrow 29) between the devices 10a, 10b, may be direct, or may be through one or more intermediate devices, such as a wireless base station for example. However, alternate embodiments may comprise any suitable communication path.

Light messaging may be provided between the first electronic device 10a and the second electronic device 10b by sending an electronic communication, such as a text message for example, and selecting a light indicating signal with the text message. To accomplish this, a user would input a text message and select a color 30 through the keypad 20a. The selection of the color 30 provides the light indicating signal to be sent with the text message (assigning the signal to the message). For example, selecting the color 30 (which may be red for example) may indicate a high priority for the message. The user would then transmit the message including the color 30 (providing the light indicating signal) from the device 10a to the device 10b. When the message is received at the device 10b, the red color 30 is displayed at the display 22b through the light element 26b. This would indicate the high priority of the text message to the user of the device 10b. The red color 30 may alternatively or additionally be transmitted to the other light elements 24b, 28b. Additionally, the above described operation may be performed from the device 10b to the device 10a, or any other suitable device.

The above described operation may apply to text messages as well as voice communications, voice messages, or any other suitable form of electronic device communication. For example, a voice communication may be performed by including a selected color for the voice communication, as described above for the text message, to indicate the priority of a voice call communication.

Additionally, the selection of the color 30, which provides the light indicating signal, may be provided as a backlight (or background color) of the voice or text communication. This would display the color 30 in the backlight of the display 22a, 22b during the communication to indicate the priority. It is to be noted that the backlight, or backlighting of the display, may be separate from the color or images on the display 22a, 22b, and that the backlighting of the display may comprise backlighting of substantially the entire display.

Furthermore, the selection of the color 30, which provides the light indicating signal, may be provided as a color for a specified emoticon, such as a smiley :-) for example. The indication of the color may specified by the sender to be applied only at the smiley, or as the background color for a text message comprising the smiley. Or, a user may have a predetermined color set to be displayed (at the emoticon only or at the light elements 24b, 26b, 28b) when the text message comprising the emoticon is received. For example, a sender of a message may send a specific smiley in the text message, and the receiver will get a specific color connected to that exact smiley. This provides for a user to configure the device 10b to display a specified color when a designated smiley (or other emoticon) is received in the communication. This could be provided even in the scenario where the sender does not designate a color with the smiley in the ‘sent’ text message. In other words, the disclosed device allows the receiver to display a specified light color or display operation in response to the received emoticon. This allows the receiver to combine specified light colors and/or display operations with specified ‘received’ emoticons. Different smileys could be represented by the same color (for example different happy-looking smileys could all be the same color).

It should be noted that although the light indicating signal has been described above with reference to the color red, alternate embodiments may comprise any other suitable color. Additionally, other parameters of the light indicating signal may be selected other than a color to indicate a user selected display operation. For example, the user selected display operation or mode may comprise displaying a pulsing, or blinking, light at the light elements 24, 26, 28. The user selected display operation or mode may also comprise displaying any suitable display operation and/or color at the light elements 24, 26, 28, for example. The light messaging signal could be totally independent of other communication signals, such as text communication signals for example, and could be used to illuminate a display before the user answers an incoming electronic communication (i.e. during the ringing of the device), such as an incoming voice call communication.

Light messaging between electronic devices may provide other benefits (other than setting a priority of a communication) such as expressing moods or emotions. This provides a sort of “very human technology”, “intelligence”, to be incorporated within the electronic device 10. Sending light messages to other users such as friends and close ones allows an improved communication which expresses moods like “I am happy”, or “angry” by selecting light indicating signals to be included with the message. For example, a blue color may indicate happiness, and a red color may indicate anger. It should be noted that the selected color(s) may indicate various emotions, such as blue to indicate/symbolize a ‘cold’ emotion, black to indicate/symbolize a ‘mad’ emotion, or pink to indicate/symbolize a ‘feminine’ emotion, for example. It is to be understood that the colors described above are included as non-limiting examples and that any suitable color and/or indication may be provided. Additionally, any suitable color (or display operation) may be provided with phrases such as “How are U?”, “Love You”, “Coming home”, “Missing U?”, etc. Furthermore, the indicating signal may be applied as a color and a display operation such as a display of a “heart beat” with a blush color and a text “I am keen on U”.

The combination of text or voice communication with lights at the light elements 24, 26, 28 may set the priority level for the call or SMS as described above. The use of the color red for high importance may be an obvious interpretation for the level of urgency. However, light messaging may also allow users to communicate only with lights, colors, and/or display operations. For example, sending only a pulsing red light to another user could mean ‘I am coming home’ with no verbal or texting communication needed, just a light communication. This is just one example and it should be noted that any other suitable light, color, and/or display operation may be provided to indicate a predetermined message.

Light messaging provides significant advantages over conventional forms of communication by making the electronic device 10 more interactive and ‘alive’, which enriches and improves the user experience. Light messaging allows for ‘socializing with lights’ by setting a priority level of an SMS or call, or expressing moods. Additionally, a user may select a color or display operation to designate a caller. Such as the color red may be designated as “wife” or a person “Ann”, or the color blue may be designated “family member” or other group for example. This would provide for the assigned color or display operation to be displayed when a communication is received from the designated person and/or group.

Another advantage is that light messaging may be provided with light elements 28 in the phone, or could also use also existing components like keymat backlights 24 or display lights 26. Light messaging may be provided as part of an SMS application, wherein before sending the SMS, or text message, the user would just chose the color of the light and display operation or effect (such as an animation for example). Or, the user may selectably configure the device 10 to allow the lights 24, 26, 28 to react automatically to emoticons, such as smileys :-), ;-(, to enhance the message with the right color.

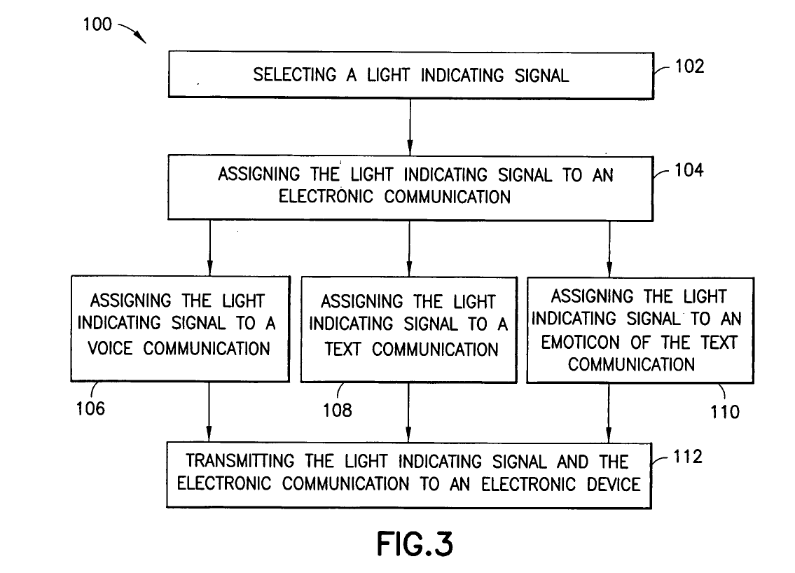

FIG. 3 illustrates an exemplary method 100 of sending a light message. The method includes the following steps. Selecting a color to indicate an emotion or other quality which is encoded into a light indicating signal (step 102). Assigning the light indicating signal to an electronic communication (step 104). Wherein the assigning the light indicating signal to the electronic communication comprises assigning the light indicating signal to a voice communication (step 106). Or, wherein the assigning the light indicating signal to the electronic communication comprises assigning the light indicating signal to a text communication (step 108). Or, wherein the assigning the light indicating signal to the electronic communication further comprises assigning the light indicating signal to an emoticon of the text communication (step 110). Transmitting the light indicating signal and the electronic communication to an electronic device (step 112). It should be noted that any of the above steps may be performed alone or in combination with one or more of the steps.

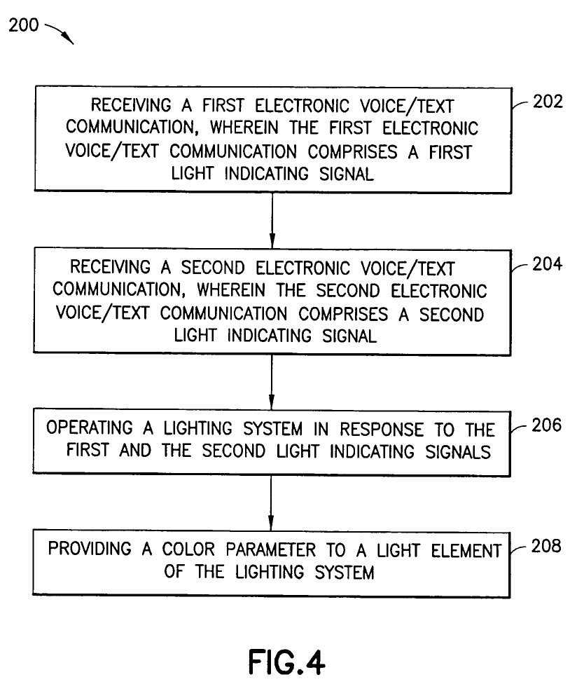

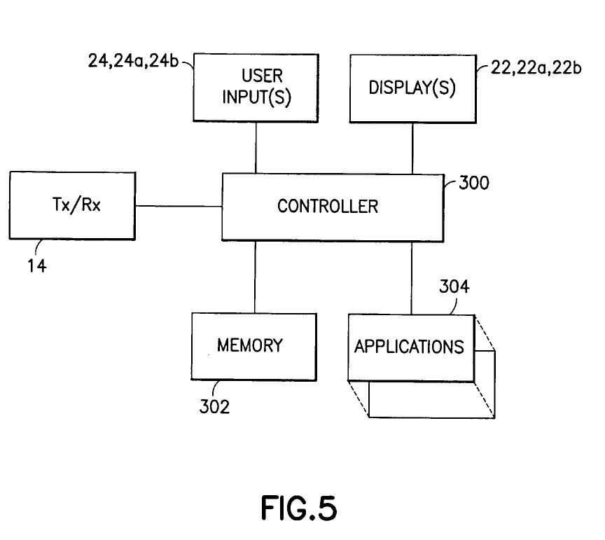

FIG. 4 illustrates an exemplary method 200 of receiving a light message. The method includes the following steps. Receiving a first electronic voice/text communication, wherein the first electronic voice/text communication comprises a first light indicating signal (step 202). Receiving a second electronic voice/text communication, wherein the second electronic voice/text communication comprises a second light indicating signal (step 204). Operating a lighting system in response to the first and the second light indicating signals (step 206). Providing a color parameter to a light element of the lighting system (step 208). It should be noted that any of the above steps may be performed alone or in combination with one or more of the steps. It should be noted that any of the above steps may be performed alone or in combination with one or more of the steps.

Referring now also to FIG. 5, the device 10, 10a, 10b generally comprises a controller 300 such as a microprocessor for example. The electronic circuitry includes a memory 302 coupled to the controller 200, such as on a printed circuit board for example. The memory could include multiple memories including removable memory modules for example. The device has applications 304, such as software, which the user can use. The applications can include, for example, a telephone application, an SMS or text messaging application, an internet browser application, etc. These are only some examples and should not be considered as limiting. One or more user inputs 24, 24a, 24b are coupled to the controller 300 and one or more displays 22, 22a, 22b are coupled to the controller 300. The transmitter/receiver 14 is also coupled to the controller 300. The device 10, 10a, 10b is preferably programmed to provide light messaging with an electronic communication by selecting a light indicating signal. The light indicating signal is assigned to the electronic communication. The light indicating signal and the electronic communication are transmitted to an electronic device.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. An electronic device comprising:
a housing; and
a transmitter within the housing, wherein the transmitter is configured to transmit an electronic communication, wherein the electronic communication comprises a light indicating signal, and wherein the electronic device is configured to allow a user to select the light indicating signal.

2. The electronic device of claim 1 wherein the transmitter is configured to transmit a wireless voice communication or a wireless text communication, and wherein the electronic device is configured to allow the user to select a color parameter of the light indicating signal.

3. The electronic device of claim 1 wherein the transmitter is configured to transmit a wireless voice communication or a wireless text communication, and wherein the electronic device is configured to allow the user to select a priority parameter or emotion parameter associated with the light indicating signal.

4. The electronic device of claim 1 wherein the transmitter is configured to transmit a wireless text communication, and wherein the electronic device is configured to allow the user to select the light indicating signal at an emoticon of the text communication.

5. The electronic device of claim 1 wherein the transmitter is configured to transmit a wireless text communication, and wherein the wireless text communication comprises a user selectable background color.

6. The electronic device of claim 1 wherein the light indicating signal comprises a parameter adapted to be read by a receiver to indicate a priority or emotion.

7. The electronic device of claim 1 wherein the light indicating signal comprises a parameter adapted to be read by a receiver to indicate a predetermined message.

8. An apparatus comprising:
a housing;
a receiver within the housing, wherein the receiver is adapted to receive a first electronic communication and a second electronic communication; and
a lighting system connected to the housing, wherein the lighting system is adapted to operate in a first mode in response to a first indicator of the first electronic communication, and wherein the lighting system is adapted to operate in a second different mode in response to a second indicator of the second electronic communication.

9. The apparatus of claim 8 wherein the lighting system comprises a light element, wherein the lighting system is adapted to the display a first color at the light element in response to the first indicator, and wherein the lighting system is adapted to display a second color at the light element in response to the second indicator.

10. The apparatus of claim 9 wherein the light element is at a display screen or keypad of the apparatus.

11. The apparatus of claim 19 wherein the light element is a multicolor light emitting diode (LED), and wherein the LED connected to the housing.

12. The apparatus of claim 8 wherein the receiver is adapted to receive a first wireless text communication, and wherein the lighting system is adapted to display a first color at a first emoticon of the first wireless text communication in response to the first indicator.

13. The apparatus of claim 12 wherein the receiver is adapted to receive a second wireless text communication, and wherein the lighting system is adapted to display a second color at a second emoticon of the second wireless text communication in response to the second indicator.

14. The apparatus of claim 8 wherein the receiver is adapted to receive a first wireless voice or text communication and a second wireless voice or text communication.

15. The apparatus of claim 8 wherein the receiver is adapted to receive a third electronic communication, and wherein the lighting system is adapted to provide a predetermined user selectable display operation in response to the third electronic communication.

16. The apparatus of claim 15 wherein the lighting system is adapted to provide a pulsing light display in response to the third electronic communication.

17. A method comprising:
selecting a light indicating signal;
assigning the light indicating signal to an electronic communication; and
transmitting the light indicating signal and the electronic communication to an electronic device.

18. The method of claim 17 wherein the assigning the light indicating signal to the electronic communication further comprises assigning the light indicating signal to a voice communication.

19. The method of claim 17 wherein the assigning the light indicating signal to the electronic communication further comprises assigning the light indicating signal to a text communication.

20. The method of claim 19 wherein the assigning the light indicating signal to the electronic communication further comprises assigning the light indicating signal to an emoticon of the text communication.

21. A method comprising:
receiving a first electronic communication, wherein the first electronic communication comprises a first light indicating signal;
receiving a second electronic communication, wherein the second electronic communication comprises a second light indicating signal; and
operating a lighting system in response to the first and the second light indicating signals.

22. The method of claim 21 wherein the receiving the first electronic communication further comprises receiving a first voice communication, and wherein the receiving the second electronic communication further comprises receiving a second voice communication.

23. The method of claim 21 wherein the receiving the first electronic communication further comprises receiving a first text communication, and wherein the receiving the second electronic communication further comprises receiving a second text communication.

24. The method of claim 21 wherein the operating the lighting system in response to the first and the second light indicating signals further comprises providing a color parameter to a light element of the lighting system.

25. A program storage device readable by a machine, tangibly embodying a program of instructions executable by the machine for performing operations to provide light messaging with an electronic communication, the operations comprising:
selecting a light indicating signal;
assigning the light indicating signal to the electronic communication; and
transmitting the light indicating signal and the electronic communication to an electronic device.
